(19) United States
(12) Patent Application Publication
(10) Pub. No.: US 2023/0286487 A1
(43) Pub. Date: Sep. 14, 2023

(54) BRAKE PACK LIFE CALCULATOR

(71) Applicant: Caterpillar Paving Products Inc., Brooklyn Park, MN (US)

(72) Inventor: Brian D. Nagel, Ramsey, MN (US)

(73) Assignee: Caterpillar Paving Products Inc., Brooklyn Park, MN (US)

(21) Appl. No.: 17/693,490

(22) Filed: Mar. 14, 2022

(51) Int. Cl. B60T 17/22; F16D 66/00

(52) U.S. Cl. CPC B60T 17/221; F16D 66/00; B60T 2250/00; F16D 2066/006; B60K 2370/152; B60K 2370/16; B60T 13/22

(57) ABSTRACT

A work machine can include a frame; a plurality of transportation devices attached to the frame; an engine to provide a propel pressure to the plurality of transportation devices; a brake pack associated with one or more of the plurality of transportation devices; and a controller configured to perform a brake pack test by receiving the propel pressure and a machine speed and wherein the controller determines a brake pack life remaining based on the propel pressure of the machine when the machine speed rises above zero.

### TECHNICAL FIELD

This disclosure relates to work equipment, and more specifically to a brake pack for a work machine.

### BACKGROUND

Work machines can be used at construction sites and other off-road locations. Such work machines can include haulers, compactors, pavers, and the like. Some work machines utilize a brake pack to provide stopping for the machine.

One issue that can arise when using a work machine is the wear and tear on the brake pack. Over time the brake packs in machines need to be replaced. Manufacturers have instruction for testing brake pack capability by parking a machine on a hill to test the brake pack but this is just a go/no go test without any specificity.

U.S. Pat. No. 10,773,702 discusses a method of determining brake wear on a vehicle by consideration of the wear of the brake pad every time the brake is actuated based on speed change parameter. The wear of each braking event is accumulated, and the remaining brake life or next expected replacement time is estimated.

### SUMMARY

In an example according to this disclosure, a work machine can include a frame; a plurality of transportation devices attached to the frame; an engine to provide a propel pressure to the plurality of transportation devices; a brake pack associated with one or more of the plurality of transportation devices; and a controller configured to perform a brake pack test by receiving the propel pressure and a machine speed and wherein the controller determines a brake pack life remaining based on the propel pressure of the machine when the machine speed rises above zero.

In another example, a method of testing a brake pack of a work machine can include applying a brake pack; increasing a propel pressure to the work machine; and determining a brake pack life remaining based on the propel pressure at a time a speed of the work machine goes above zero.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 schematically shows a work machine, in accordance with one embodiment.

FIG. 2 shows a control system for performing the brake pack test, in accordance with one embodiment.

FIG. 3 shows a method of testing a brake pack of a work machine, in accordance with one embodiment.

### DETAILED DESCRIPTION

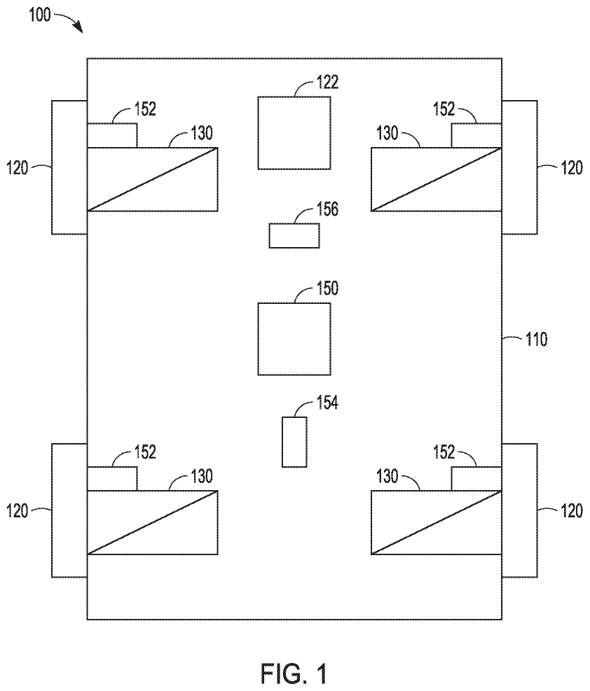

FIG. 1 schematically shows a work machine 100, in accordance with one embodiment. The work machine 100 generally includes a frame 110. The work machine 100 further includes a plurality of transportation devices, such as wheels 120, attached to the frame 110. In some examples, the work machine 100 can include an articulated truck, a compactor, a paver, haul truck, an autonomous machine, and the like. In other examples, the machine 100 can include a compaction machine and the transportation device can include a steel drum that is driven by a motor/gear box that has a brake pack. For example, this could include vibratory asphalt and soil compactors which have a drum on the front and either a drum or tires in the rear. Depending on the type of machine, the work machine 100 can include any number of transportation devices, such as wheels 120 or drum rollers. For example, a machine can include two wheels, four wheels, six wheels, one or two drum rollers, or more.

The machine 100 can include an engine 122 for providing propel power to the wheels 120 and being supported by the frame 110.

Further, the work machine 100 can include one or more brake packs 130 associated with one or more of the plurality of wheels 120. For example, in one embodiment, a single brake pack 130 can be used for the front wheels 120 and one brake pack 130 can be used for the back wheels 120. In one embodiment, each wheel 120 of the work machine 100 can include a separate brake pack 130. The brake pack 130 uses hydraulic pressure and physical mechanisms to slow down and stop the wheels from rotating. The brake pack 130 can include a spring applied, hydraulically released brake pack.

As discussed above, one issue that can arise when using the work machine 100 is wear and tear on the brake pack 130. A given brake pack 130 has a given life expectancy depending on usage. Over time the brake packs in machines wear and need to be replaced. Manufacturers have instruction for testing brake pack capability by parking a machine on a hill but this is just a pass/fail test without specificity.

In the present system, the system can calculate the remaining life of a brake pack and advise if service is needed. For example, the work machine 100 can include a controller 150 that can be operably coupled to the engine 122, the brake packs 130 and the other components of the work machine 100.

In one embodiment, the controller 150 can be configured to perform a brake pack test on the brake packs 130. For example, with the brakes applied, the engine 122 can begin to try to propel the wheels 120. The controller 150 can receive the propel pressure being applied to the wheels 120. The work machine 100 can also include one or more speed sensors 152 operably coupled to the wheels 120 to determine a speed of the wheels 120. The wheel speed from the sensors 152 can also be relayed to the controller 150. From the propel pressure information and the wheel speed information the controller 150 can be configured to determine the brake pack life remaining.

For example, when the wheel speed rises above zero (e.g., when the propel pressure overcomes the brakes and the wheels begin to turn), the controller 150 can determine the brake pack life remaining based on the propel pressure at that moment. The brake pack life remaining means the useful, functional life of the brake pack. When the work machine 100 moves, the controller 150 knows that the braking limit of the current state of the brake pack 130 has been reached and then in terms of the propel pressure, the specific work machine 100 and the specific brake pack 130 being tested, the controller 150 can develop an estimate of brake pack life remaining. The propel pressure needed to overcome the brakes will go down over the life of the brake pack 130. Based on empirical data and work site usage, a reliable estimate of the brake pack life remaining can be developed over time.

In one embodiment, the brake pack life remaining can be shown as a percentage of total brake pack life. Based on the percentage, the operator can determine if maintenance, repair, or replacement is needed for the specific brake pack 130.

In one example, the work machine 100 can include an angle sensor 154 coupled to the controller 150. The angle that the work machine 100 is positioned on can then also be used by the controller 150 to help determine brake pack life remaining.

In one example, the controller 150 can keep track of the number of times the brake pack has been used. The controller 150 can then use the number of prior stops performed by the brake pack 130 to help determine the brake pack life remaining.

As noted, the brake pack life remaining can be defined as a percentage of brake pack life remaining based on the overall brake pack life. For example, the overall brake pack life can be determined based on the specific work machine and the manufacturer's suggested brake life, and also can be based on empirical evidence, actual usage statistics, etc. Thus, over time, the system can accumulate data based on the specific machine and the specific brake pack and thus will know that if work machine X has a brake pack Y, then a brake pack test propel speed of Z means the brake pack has a specific percentage of life remaining. As noted, in general, as the propel pressure to overcome the brakes goes down, then brake pack life remaining is less.

In one example, the percentage can be displayed to an operator of the work machine on an operator's display 156. In some examples, the percentage of brake pack life remaining can be sent to a remote location for analysis.

The brake pack test discussed herein can be performed at different time intervals. For example, the brake pack test can occur at the machine operator's discretion. For example, the operator can be instructed to perform the brake pack test daily, weekly, or monthly.

In one example, the brake pack test can occur automatically each time the work machine 100 is powered on. This can be advantageous if the work machine 100 is an autonomous machine, where at start-up, the work machine 100 is put through various start-up tests including a brake pack life test.

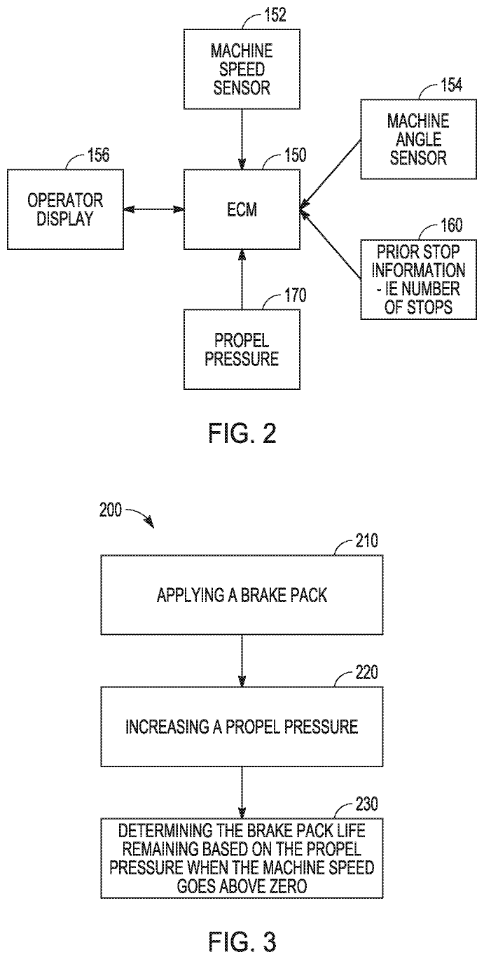

FIG. 2 shows a control system for performing the brake pack test. Here the controller 150 can receive information including machine speed from the machine speed sensor 152, machine angle information from the machine angle sensor 154, receive the number of prior stops 160, and receive the propel pressure 170. Using this input information, the controller 150 can determine, when the machine speed goes above zero, what the brake pack remaining life is. This information can be sent to the operator display 156 or can be stored for later analysis.

In summary, once in test mode, the brakes are applied and the work machine uses its propel system to try and drive through the brake pack to determine how well the brakes are working. The propel pressure can be measured to calculate how much force it took to overpower the brakes. This force can then be correlated to a brake pack life remaining by knowing when the machine started to move (and what angle the machine was at during the test, etc.). The brake pack life value could be displayed to the operator or sent via the cloud to schedule maintenance.

### INDUSTRIAL APPLICABILITY

The present system is applicable during many situations in road construction. Again, the brake pack life test can be utilized by an articulated truck, a compactor, a paver, haul truck, an autonomous machine, and the like.

FIG. 3 shows a method (200) of testing a brake pack of a work machine. The method (200) can include applying a brake pack (210), so as to apply the brakes to all the transportation devices of the work machine 100. The method (200) further includes increasing a propel pressure (220) to the work machine and determining the brake pack life remaining (230) based on the propel pressure at a time a speed of the work machine goes above zero.

As discussed above, the method (200) can further include determining an angle of the work machine and also using the machine angle to determine the brake pack life remaining. The method (200) can also include determining a number of prior stops performed by the brake pack to determine the brake pack life remaining.

Again, the brake pack life remaining can be defined as a percentage of the brake pack life remaining. The percentage can be displayed to the operator of the work machine or sent to a remote location. In some examples, the method can further include advising whether brake pack service is required based on the brake pack test.

Accordingly, the present system is related to the field of brake pack life detecting mechanisms in compactors, pavers, haul trucks, autonomous machines, and the like. According to the present system, a feature is provided which notifies an operator if service is needed based on calculated remaining brake life. An electronic chip module (ECM) controller can be configured to detect the machine propel pressure, the machine wheel speed, and other factors such machine angle and number of prior brake stops. The controller calculates remaining brake life based on the detected values and notifies an operator if service is needed based on the calculated remaining brake life. This system can also be a useful safety check for autonomous machines.

Various examples are illustrated in the figures and foregoing description. One or more features from one or more of these examples may be combined to form other examples.

The above detailed description is intended to be illustrative, and not restrictive. The scope of the disclosure should, therefore, be determined with references to the appended claims, along with the full scope of equivalents to which such claims are entitled.

What is claimed is:

1. A work machine comprising:
a frame;
a plurality of transportation devices attached to the frame;
an engine to provide a propel pressure to the plurality of transportation devices;
a brake pack associated with one or more of the plurality of transportation devices; and
a controller configured to perform a brake pack test by receiving the propel pressure and a machine speed and wherein the controller determines a brake pack life remaining based on the propel pressure of the machine when the machine speed rises above zero.

2. The work machine of claim 1, wherein when the brake pack test is performed by the controller, the brake pack applies a braking pressure to the transportation devices before the brake pack test.

3. The work machine of claim 1, wherein the controller further receives an angle of machine and also uses the machine angle to determine the brake pack life remaining.

4. The work machine of claim 1, wherein the controller further receives a number of prior stops performed by the brake pack to determine the brake pack life remaining.

5. The work machine of claim 1, wherein the brake pack life remaining is defined as a percentage of brake pack life remaining.

6. The work machine of claim 5, wherein the percentage is displayed to an operator of the machine.

7. The work machine of claim 5, wherein the percentage is stored at a remote location.

8. The work machine of claim 1, wherein the brake pack test occurs at a machine operator's discretion.

9. The work machine of claim 1, wherein the brake pack test occurs every time the machine is powered on.

10. The work machine of claim 1, wherein the brake pack includes a spring applied, hydraulically released brake pack.

11. A method of testing a brake pack of a work machine, the method comprising:
applying a brake pack;
increasing a propel pressure to the work machine; and
determining a brake pack life remaining based on the propel pressure at a time a speed of the work machine goes above zero.

12. The method of claim 11, further including determining an angle of the work machine and also using the machine angle to determine the brake pack life remaining.

13. The method of claim 11, further including determining a number of prior stops performed by the brake pack to determine the brake pack life remaining.

14. The method of claim 11, wherein the brake pack life remaining is defined as a percentage of the brake pack life remaining.

15. The method of claim 14, including displaying the percentage to an operator of the machine.

16. The method of claim 14, including storing the percentage at a remote location.

17. The method of claim 11, wherein testing the brake pack life remaining occurs at a machine operator's discretion.

18. The method of claim 11, wherein testing the brake pack life remaining occurs every time the machine is powered on.

19. The method of claim 11, including advising whether brake pack service is required based on the brake pack test.

20. The method of claim 11, wherein the brake pack test is performed automatically on an autonomous work machine.
